(19) United States
(12) Patent Application Publication
(10) Pub. No.: US 2026/0120596 A1
(43) Pub. Date: Apr. 30, 2026

(54) PROJECTION IMAGE CORRECTION SYSTEM AND PROJECTION IMAGE CORRECTION METHOD

(71) Applicant: SigmaStar Technology Ltd., Xiamen (CN)

(72) Inventors: Junyu OUYANG, Shanghai (CN); Bo ZHANG, Shanghai (CN); Jiannan SHEN, Shanghai (CN); Kuei-Hung CHENG, Taiwan (TW); Cheng-Hung TSAI, Taiwan (TW)

(21) Appl. No.: 19/357,409

(22) Filed: Oct. 14, 2025

(30) Foreign Application Priority Data
Oct. 24, 2024 (CN) 202411493236.3

(51) Int. Cl. G09G 3/00

(52) U.S. Cl. CPC G09G 3/001; G09G 2320/029; G09G 2340/14

(57) ABSTRACT

A projection image correction system includes a state control circuit, issuing a read request corresponding to an interpolation operation to a first memory when the read request has not been sent to the first memory to obtain first pixel information, storing the first pixel information to a second memory, and counting the number of read requests sent to the first memory to generate a first count value; and a data output circuit, counting according to a write completion signal to generate a second count value, and obtaining second pixel information for the interpolation operation from the second memory for an interpolation device when the second count value is equal to the first count value to perform the interpolation operation. The write completion signal indicates that the first pixel information has been stored to the second memory, and the second pixel information includes the first pixel information.

This application claims the benefit of China application Serial No. CN202411493236.3, filed on Oct. 24, 2024, the subject matter of which is incorporated herein by reference.

### BACKGROUND OF THE INVENTION

### Field of the Invention

The present application relates to a projection image correction system, and more particularly, to a projection image correction system and a projection image correction method having a cache mechanism able to successively receive read requests and send read requests.

### Description of the Related Art

A projection image displayed by a projector usually contains distortion (for example, trapezoidal distortion). To correct the projection image above, a projection image correction system usually may obtain pixel information neighboring to a distorted image region to perform an interpolation operation to thereby correct the distorted image region. In the prior art, a control mechanism of a line buffer or a universal cache is used to implement a data access mechanism of the projection image correction system. In the configuration of a line buffer, pixel information used for image correction is buffered at the expense of a larger storage space and higher hardware costs. In the configuration of a universal cache, only one round of read/write can be performed for one cache line in the cache in one cycle, and a next round of read/write can be performed only one read/write request has been fully processed, such that the projection image correction system necessarily consumes a large amount of time for data access, leading to significant poor overall processing efficiency.

### SUMMARY OF THE INVENTION

In some embodiments, it is an object of the present application to provide a projection image correction system and a projection image correction method having a cache mechanism able to successively receive read requests and send read requests to improve the issues of the prior art.

In some embodiments, a projection image correction system includes a state control circuit and a data output circuit. The state control circuit issues at least one read request corresponding to an interpolation operation to a first memory when the least one read request has not yet been sent to the first memory to obtain at least one set of first pixel information from the first memory, stores the at least one set of first pixel information to a second memory, and counts the number of the at least one read request sent to the first memory to generate a first count value. The data output circuit counts according to at least one write completion signal to generate a second count value, and obtains a plurality of sets of second pixel information used for the interpolation operation from the second memory for an interpolation device when the second count value is equal to the first count value, for the interpolation device to perform the interpolation operation according to the plurality of sets of second pixel information. The at least one write completion signal indicates that the least one set of first pixel information has been stored to the second memory, and the plurality of sets of second pixel information include the at least one set of first pixel information.

In some embodiments, a projection image correction method performed by a projection image correction system includes operations of: issuing at least one read request corresponding to an interpolation operation to a first memory when the at least one read request has not yet been sent to the first memory to obtain at least one set of first pixel information, and storing the at least one set of first pixel information to a second memory of the projection image correction system; counting the number of the at least one read request sent to the first memory to generate a first count value; counting according to a write completion signal to generate a second count value; and obtaining a plurality of sets of second pixel information used for the interpolation operation from the second memory for an interpolation device when the second count value is equal to the first count value, for the interpolation device to perform the interpolation operation according to the plurality of sets of second pixel information, wherein the at least one write completion signal indicates that the at least one set of first pixel information has been stored to the second memory, and the plurality of sets of second pixel information include the at least one set of first pixel information.

Features, implementations and effects of the present application are described in detail in preferred embodiments with the accompanying drawings below.

### BRIEF DESCRIPTION OF THE DRAWINGS

To better describe the technical solution of the embodiments of the present application, drawings involved in the description of the embodiments are introduced below. It is apparent that, the drawings in the description below represent merely some embodiments of the present application, and other drawings apart from these drawings may also be obtained by a person skilled in the art without involving inventive skills.

FIG. 1 shows a schematic diagram of a projection image correction system according to some embodiments of the present application.

FIG. 2 shows a schematic diagram of the memory in FIG. 1 according to some embodiments of the present application.

FIG. 3 shows a schematic diagram of the state control circuit in FIG. 1 according to some embodiments of the present application.

FIG. 4 shows a schematic diagram of operations of resorting of the data sorting circuit in FIG. 1 according to some embodiments of the present application.

FIG. 5 shows a schematic diagram of the data output circuit in FIG. 1 according to some embodiments of the present application.

FIG. 6A shows a flowchart of operations of a first part of one round of interpolation operation performed by the projection image correction device in FIG. 1 according to some embodiments of the present application.

FIG. 6B shows a flowchart of operations of a second part of one round of interpolation operation performed by the projection image correction device in FIG. 1 according to some embodiments of the present application.

FIG. 7 shows a timing diagram of multiple read requests performed by the projection image correction system in FIG. 1 according to some embodiments of the present application.

FIG. 8 shows a flowchart of a projection image correction method according to some embodiments of the present application.

### DETAILED DESCRIPTION OF THE INVENTION

All terms used in the literature have commonly recognized meanings. Definitions of the terms in commonly used dictionaries and examples discussed in the disclosure of the present application are merely exemplary, and are not to be construed as limitations to the scope or the meanings of the present application. Similarly, the present application is not limited to the embodiments enumerated in the description of the application.

The term “coupled” or “connected” used in the literature refers to two or multiple elements being directly and physically or electrically in contact with each other, or indirectly and physically or electrically in contact with each other, and may also refer to two or more elements operating or acting with each other. As given in the literature, the term “circuit” may be a device connected by at least one transistor and/or at least one active element by a predetermined means so as to process signals.

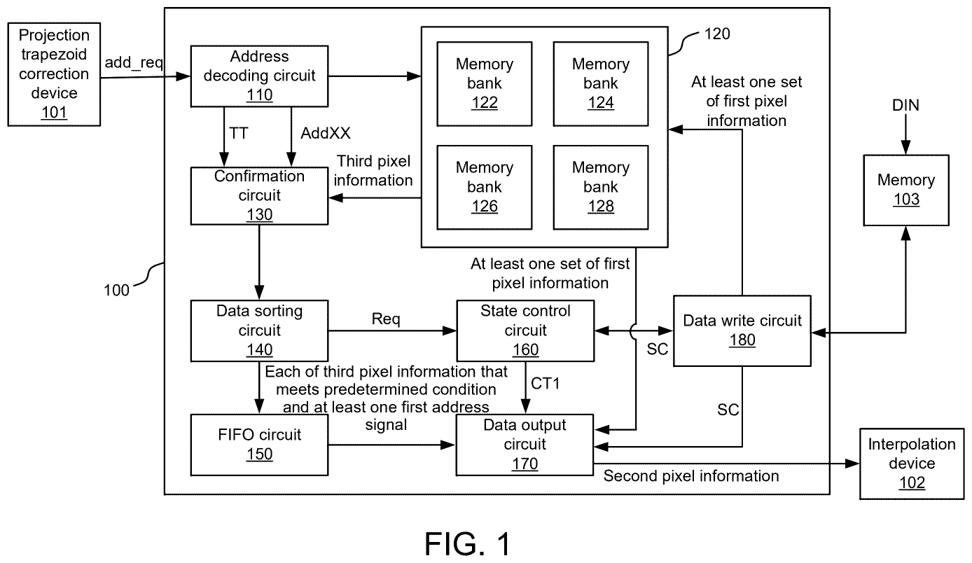

FIG. 1 shows a schematic diagram of a projection image correction system 100 according to some embodiments of the present application. In some embodiments, a projection trapezoid correction device 101 may output an address request signal add_req to the projection image correction system 100 according to an image correction algorithm (for example but not limited to, interpolation correction) executed for a distorted image, so that the projection image correction system 100 may provide all pixel information (to be referred to as a plurality of sets of second pixel information below) used for one round of interpolation operation to an interpolation device 102, thus the interpolation device 102 performing the interpolation operation according to the plurality of sets of second pixel information to thereby correct distortion in a projection image.

The projection image correction system 100 includes an address decoding circuit 110, a memory 120, a confirmation circuit 130, a data sorting circuit 140, a first-in-first-out (FIFO) circuit 150, a state control circuit 160, a data output circuit 170 and a data write circuit 180. The address decoding circuit 110 may receive the address request signal add_req from the projection trapezoid correction device 101, decode the address request signal add_req to obtain multiple address signals AddXX, and transmit the address signals AddXX to the memory 120.

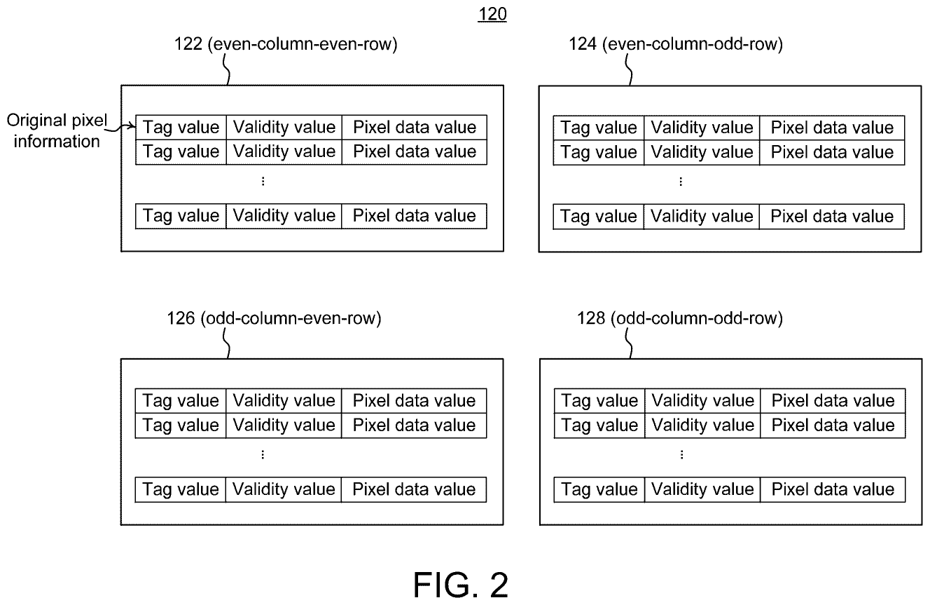

The memory 120 includes a memory bank 124, a memory bank 124, a memory bank 126 and a memory bank 128. In some embodiments, the memory bank 122, the memory bank 124, the memory bank 126 and the memory bank 128 may store multiple sets of pixel information of original image data DIN according to a predetermined order. For example, the memory 120 is further coupled to a memory 103 through the data write circuit 180, wherein the memory 103 stores multiple sets of original pixel information of the original image data DIN. The memory 120 may obtain the original image data DIN from the memory 103 through the data write circuit 180, and store the multiple sets of original pixel information of the original image data DIN according to the predetermined order to the memory bank 122, the memory bank 124, the memory bank 126 and the memory bank 128. Associated details herein are to be described with reference to FIG. 2 below.

The confirmation circuit 130 may read multiple sets of pixel information (to be referred to as a plurality of sets of third pixel information below) from the memory bank 122, the memory bank 124, the memory bank 126 and the memory bank 128 according to the address signals AddXX. In some embodiments, the memory 103 is a dynamic random access memory (DRAM), and the memory 120 is a static random access memory (SRAM). The confirmation circuit 130 may confirm whether each of the plurality of sets of third pixel information meets a predetermined condition. For example, each set of the third pixel information includes a tag and a validity value. The confirmation circuit 130 compares a tag value of a corresponding one of the plurality of sets of third pixel information with a target tag value TT to confirm whether the tag value of the corresponding one is the same as the target tag value TT, and confirms whether a validity value of the corresponding one is a predetermined value. If the tag value of the corresponding one is the same as the target tag value and the validity value of the corresponding one is the predetermined value, the confirmation circuit 130 may confirm that the corresponding one of the plurality of sets of third pixel information meets the predetermined condition (equivalent to a read hit). Alternatively, if the tag value of the corresponding one is different from the target tag value and/or the validity value of the corresponding one is not the predetermined value, the confirmation circuit 130 may confirm that the corresponding one of the plurality of sets of third pixel information does not meet the predetermined condition (equivalent to a read miss). Similarly, the confirmation circuit 130 may confirm whether each of the plurality of sets of third pixel information meets the predetermined condition.

In some embodiments, the validity value above is for indicating whether the corresponding set of third pixel information is in a valid state (for example, an available state). For example, when the validity value is a first logical value, the corresponding set of third pixel information is in a valid state; conversely, when the validity value is a second logical value, the corresponding set of third pixel information is in an invalid state and cannot be used for the interpolation operation. In some embodiments, the address decoding circuit 110 may decoded the address request signal add_req to obtain the target tag value TT above, and provide the target tag value TT to the confirmation circuit 130. In some embodiments, the confirmation circuit 130 may be implemented by a comparison circuit; however, the present application is not limited to the example above.

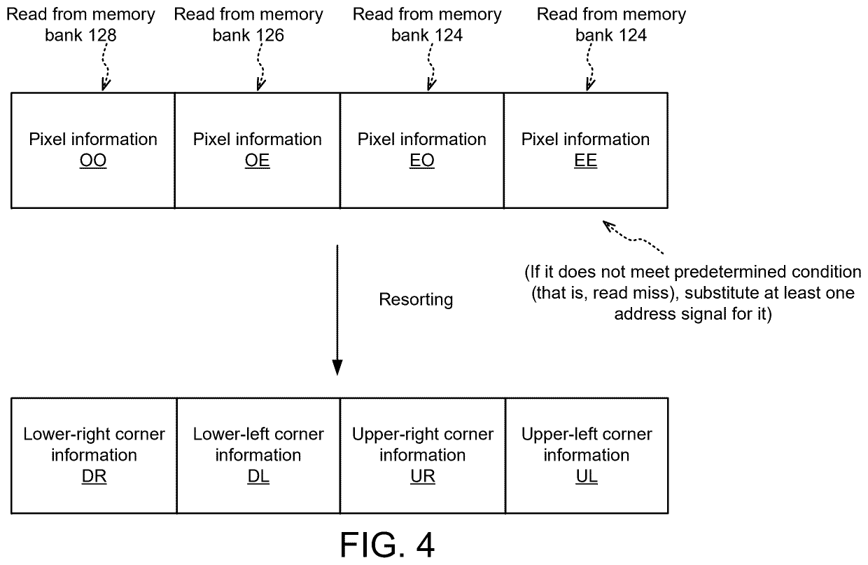

The data sorting circuit 140 is coupled to the confirmation circuit 130, and determines according to the confirmation result (for example, a result corresponding to a read miss) of the confirmation circuit 130 that the memory 120 lacks at least one set of first pixel information and accordingly issues at least one read request req, so as to obtain the at least one set of first pixel information from the memory 130 through the state control circuit 160. The at least one set of first pixel information lacking from the memory 120 corresponds to at least one of the plurality of sets of third pixel information that does not meet the predetermined condition above. Moreover, according to the confirmation result of the confirmation circuit 130, the data sorting circuit 140 further resorts each of the plurality of sets of third pixel information that meets the predetermined condition above and at least one first address signal (corresponding to the at least one set of first pixel information above) of the multiple address signals AddXX, and accordingly outputs each of the plurality of sets of third pixel information that meets the predetermined condition above and the at least one first address signal having been resorted to the FIFO circuit 150. Associated details herein are to be described with reference to FIG. 4 below.

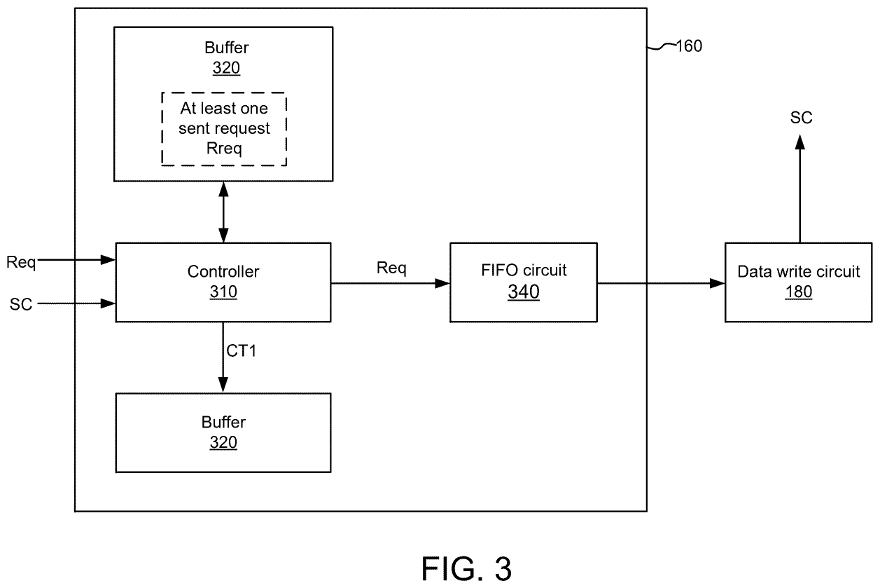

The state control circuit 160 issues the at least one read request Req to the memory 103 when the read request Req has not yet been sent to the memory 103 to obtain the at least one set of first pixel information from the memory 103, and accordingly stores the at least one set of first pixel information to the memory 120. During the process above, the state control circuit 160 further counts the number of the at least one read request Req sent to the memory 103 to generate a count value CT1. Associated details of the configuration of the state control circuit 160 are to be described with reference to FIG. 3 below.

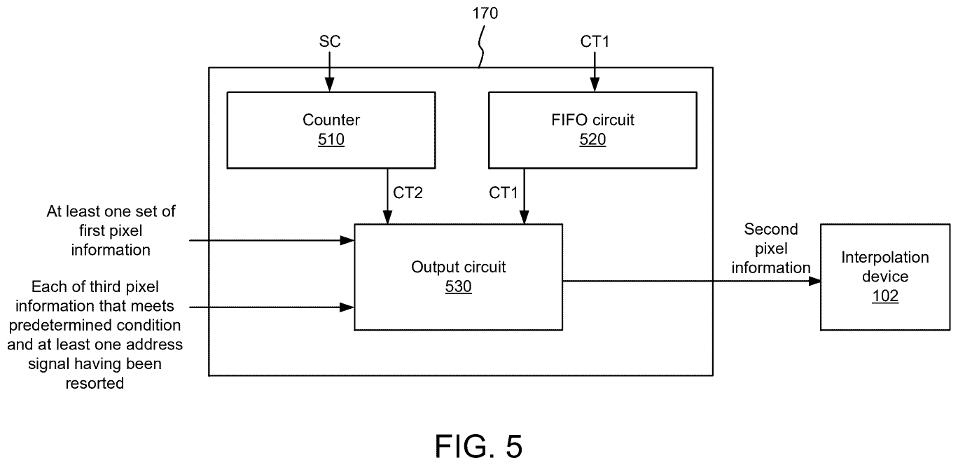

More specifically, the state control circuit 160 issues the at least one read request Req to the data write circuit 180. The data write circuit 180 may obtain at least one first address signal (which may indicate address information of the at least one set of first pixel information in the original image data DIN) according to the at least one read request Req, so as to read the at least one set of first pixel information from the memory 103. Accordingly, the data write circuit 180 may store the at least one set of first pixel information to the memory 120, and issue at least one write completion signal SC to the data output circuit 170, wherein the at least one write completion signal SC is for indicating that the at least one set of first pixel information has been stored to the memory 120. Accordingly, the data output circuit 170 may count according to the at least one write completion signal SC to generate another count value (for example, the count value CT2 in FIG. 5), and obtain, when the count value CT2 is equal to the count value CT1, a plurality of sets of second pixel information (including the at least one set of first pixel information above and each of the plurality of sets of third pixel information that meets the predetermined condition above) needed to perform one round of interpolation operation from the memory 120 and the data sorting circuit 140 (through the FIFO circuit 150) within a same time cycle. Thus, the data output circuit 170 may output the plurality of sets of second pixel information to the interpolation device 102 to perform the interpolation operation to thereby correct the projection image.

FIG. 2 shows a schematic diagram of the memory 120 in FIG. 1 according to some embodiments of the present application. As described above, the memory bank 122, the memory bank 124, the memory bank 126 and the memory bank 128 of the memory 120 may store multiple sets of original pixel information of the original image data DIN according to a predetermined order. For example, according to coordinate positions in the original image data DIN, multiple sets of original pixel information may be stored to the memory bank 122, the memory bank 124, the memory bank 126 and the memory bank 128 according to an order (that is, the predetermined order above) of even-column-even-row, even-column-odd-row, odd-column-even-row and odd-column-odd-row, wherein each set of original pixel information stored in the memory 120 may include the tag value, the validity value and a pixel data value. The memory bank 124, a memory bank 124, a memory bank 126 and a memory bank 128 may be separately accessed. In some related art, a projection image correction system is only able to sequentially read multiple sets of pixel data from a memory within multiple cycles, leading to lower overall processing efficiency. Different from the related art above, with the configuration described above, the projection image correction system 100 is able to obtain multiple sets of pixel information from the memory bank 122, the memory bank 124, the memory bank 126 and the memory bank 128 within the same time cycle.

FIG. 3 shows a schematic diagram of the state control circuit 160 in FIG. 1 according to some embodiments of the present application. In some embodiments, the state control circuit 160 records at least one sent request Rreq, and compares whether the at least one read request Req with the at least one sent request Rreq to confirm whether the at least one read request Req has not yet been sent to the memory 103. For example, as shown in FIG. 3, the state control circuit 160 includes a controller 310, a buffer 320, a buffer 330 and a FIFI circuit 340. The controller 310 receives the at least one read request Req and the at least one write completion signal SC. The buffer 320 stores related information (for example but not limited to, position information of pixel information that the at least one sent request Rreq intends to access) of the at least one sent request Rreq. The controller 310 may compare whether the at least one read request Req received is the same as the at least one sent request Rreq in the buffer 320. If the at least one read request Req is the same as the at least one sent request Rreq, it means that the at least one read request Req has previously been sent to the memory 103 through the data write circuit 180. In this case, the controller 310 does not again issue the at least one read request Req to the memory 103.

On the other hand, if the at least one read request Req is different from the at least one sent request Rreq, it means that the at least one read request Req has not yet been sent to the memory 103 through the data write circuit 180. In this case, the controller 310 issues the at least one read request Req to the memory 103 through the data write circuit 180. For example, when the at least one read request Req is different from the at least one sent request Rreq, the controller 310 may issue the at least one read request Req to the FIFO circuit 340, accordingly issue the at least one read request Req through the FIFO circuit 340 to the data write circuit 180, and then issue the at least one read request Req to the memory 103 through the data write circuit 180. Meanwhile, the controller 310 stores the at least one read request Req to the buffer 320 to update the at least one sent request Rreq (that is, recording the at least one read request Req as one of the at least one sent request Rreq), and count the number of the at least one read request Req sent to the memory 103 to generate the count value CT1. The buffer 330 is further used to store the count value CT1.

In some embodiments, the data sorting circuit 140 at the same time sends a tag signal (not shown) while sending a last read request in the at least one read request Req to notify the controller 310 that the last read request corresponding to one round of interpolation operation has been completely sent. Accordingly, after the count value CT1 has been sent to the data output circuit 170, the controller 310 may reset the count value CT1 to 0, so as to prepare to count the number of at least one read request Req corresponding to the next round of interpolation operation. In some embodiments, the controller circuit 310 may be implemented by a microcontroller circuit or a digital processing circuit above to execute a state machine; however, the present application is not limited to the examples above.

In some other embodiments, the state control circuit 160 may include more buffers (not shown), which may be used to buffer the at least one set of first pixel information, so that the data output circuit 170 may directly obtain the at least one set of first pixel information from these buffers (instead of from the memory 120). Thus, the waiting time for the data output circuit 170 to obtain the at least one set of first pixel information can be reduced to further improve overall data access efficiency.

FIG. 4 shows a schematic diagram of operations of resorting of the data sorting circuit 140 in FIG. 1 according to some embodiments of the present application. In some embodiments, each of the multiple address signals AddXX may further include offset information. If the confirmation circuit 130 confirms that the third pixel information read from the memory 120 meets the predetermined condition (that is, a read hit), the data sorting circuit 140 may read and resort several corresponding bits in the pixel data value from the third pixel information according to the offset information corresponding to the third pixel information. Alternatively, if the confirmation circuit 130 confirms that the third pixel information read from the memory 120 does not meet the predetermined condition (that is, a read miss), the data sorting circuit 140 may resort at least one address signal corresponding to the third pixel information that does not meet the predetermined condition. More specifically, the confirmation circuit 130 may fetch one set of third pixel information from each of the memory bank 122, the memory bank 124, the memory bank 126 and the memory bank 128 within the same time cycle according to the address signals AddXX corresponding to one address request signal add_req, wherein the corresponding pixel points are respectively located even-column-even-row, even-column-odd-row, odd-column-even-row and odd-column-odd-row positions in the original image data DIN. However, in the interpolation operation, the positions of these pixel points are categorized as an upper-left corner, an upper-right corner, a lower-left corner and a lower-right corner in terms of mapping coordinates. The resorting performed by the data sorting circuit 140 is to complete the position translation above.

As shown in FIG. 4, the third pixel information read from the memory bank 122 is labeled as pixel information EE, the third pixel information read from the memory bank 124 is labeled as pixel information EO, the third pixel information read from the memory bank 126 is labeled as pixel information OE, and the third pixel information read from the memory bank 128 is labeled as pixel information OO, which are arranged in a predetermined order of even-column-even-row, even-column-odd-row, odd-column-even-row and odd-column-odd-row. During the resorting, the pixel information EE, the pixel information EO, the pixel information OE and the pixel information OO are resorted into upper-left corner information UL, upper-right corer information UR, lower-left corner information DL and lower-right corner information DR, which are accordingly input to the FIFO circuit 150.

It should be understood that, if one set of corresponding pixel information in the pixel information EE, the pixel information EO, the pixel information OE and the pixel information OO meets the predetermined condition above, the contents of the corresponding pixel information are the corresponding several bits in the pixel data value described above. Conversely, if the corresponding pixel information does not meet the predetermined condition above (that is, a read miss), the contents of the corresponding pixel information are the address signal (that is, the at least first address signal above) corresponding to the corresponding pixel information. In other words, the data having been resorted contains the address signal corresponding to pixel information of a read miss and pixel information of a read hit. Thus, the data output circuit 170 may read the pixel information originally of a read miss (that is, the at least one set of first pixel information) from the memory 120 according to the address signal, read the corresponding several bits in the pixel data value, and substitutes these bits for a data part of the corresponding address signal in the resorted data, so as to accordingly provide the interpolation device 102 with multiple sets of second pixel information needed for this round of interpolation operation.

FIG. 5 shows a schematic diagram of the data output circuit 170 in FIG. 1 according to some embodiments of the present application. The data output circuit 170 includes a counter 510, a FIFO circuit 520 and an output circuit 530. The counter 510 receives the at least one write completion signal SC from the data write circuit 180, and counts the at least one write completion signal SC received to generate the count value CT2. The FIFO circuit 520 receives the count value CT1 from the state control circuit 160. The output circuit 530 obtains the count value CT1 from the FIFO circuit 520, and when the count value CT2 is equal to the count value CT1 (equivalent to that all of the at least one read request Req corresponding to one address request signal add_req has been sent to the memory 103, and the memory 120 has completely obtained all of the lacking at least one set of first pixel information from the memory 103), obtains the at least one set of first pixel information from the memory 120 and obtains the at least one first address signal and each of the plurality of sets of third pixel information that meets the predetermined condition having been resorted from the data sorting circuit 140, and substitutes the at least one set of first pixel information for the contents of the at least one first address signal therein, so as to output the at least one set of first pixel information and each of the plurality of sets of third pixel information that meets the predetermined condition having been resorted as the plurality of sets of second pixel information, to provide the interpolation device 102 with the pixel information needed to perform this round of interpolation operation.

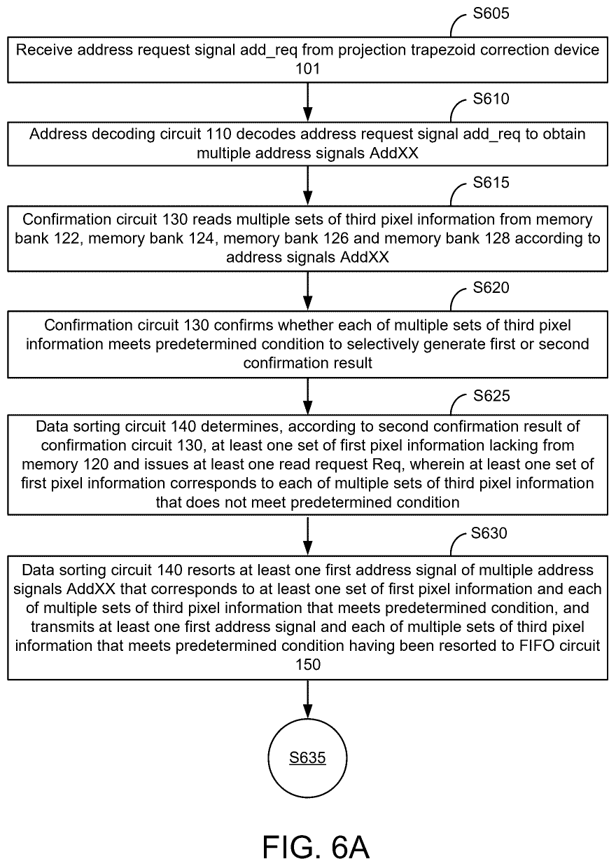

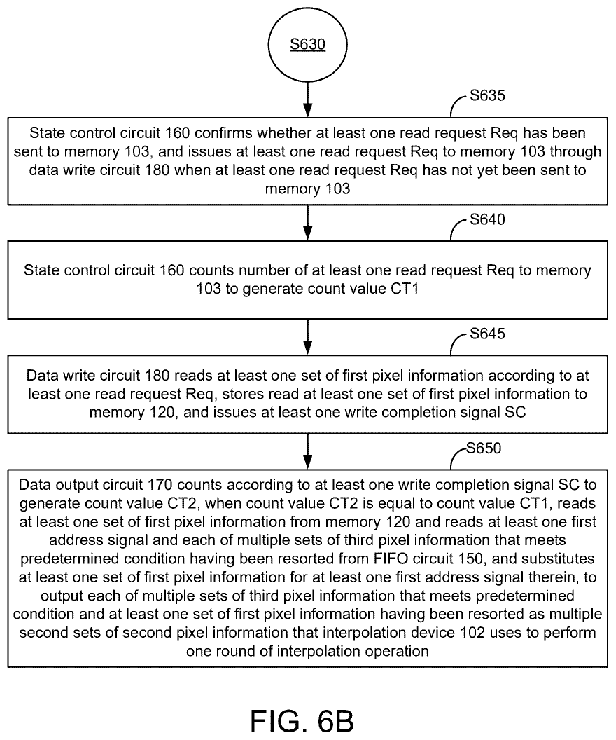

FIG. 6A shows a flowchart of operations of a first part of a round of interpolation operation performed by the projection image correction system 100 in FIG. 1 according to some embodiments of the present application, and FIG. 6B shows a flowchart of operations of a second part of the round of interpolation operation performed by the projection image correction system 100 in FIG. 1 according to some embodiments of the present application. In operation S605, the address request signal add_req is received from the projection trapezoid correction device 101. In operation S610, the address decoding circuit 110 decodes the address request signal add_req to obtain multiple address signals AddXX. For example, as shown in FIG. 2 and FIG. 4, the third pixel information respectively stored in the memory bank 122, the memory bank 124, the memory bank 126 and the memory bank 128 is the pixel information EE, the pixel information EO, the pixel information OE and the pixel information OO. The address decoding circuit 110 may decode the address request signal add_req according to a pixel mapping coordinate relationship of the original image data DIN to obtain the multiple address signals AddXX, where XX may correspond to the multiple sets of pixel information EE, EO, OE and OO above. For example, an address signal AddEE may represent a corresponding storage address in the memory bank 122, an address signal AddEO may represent a corresponding storage address in the memory bank 124, an address signal AddOE may represent a corresponding storage address in the memory bank 126, and an address signal AddEE may represent a corresponding storage address in the memory bank 128.

Also referring to FIG. 6A, in operation S615, the confirmation circuit 130 reads a plurality of sets of third pixel information from the memory bank 122, the memory bank 124, the memory bank 126 and the memory bank 128 according to these address signals AddXX. In operation S620, the confirmation circuit 130 confirms whether each of the plurality of sets of third pixel information meets a predetermined condition (that is, whether it is a read hit) to selectively generate a first or second confirmation result. If so, the confirmation circuit 130 generates a first confirmation result to indicate that the third pixel information meets the predetermined condition; if not, the confirmation circuit 130 generates a second confirmation result to indicate that the third pixel information does not meet the predetermined condition. In operation S625, the data sorting circuit 140 determines, according to the second confirmation result of the confirmation circuit 130, at least one set of first pixel information lacking from the memory 120 and accordingly issues at least one read request Req, wherein the at least one set of first pixel information corresponds to each of the plurality of sets of third pixel information that does not meet the predetermined condition. In operation S630, the data sorting circuit 140 resorts at least one first address signal of the multiple address signals AddXX that corresponds to the at least one set of first pixel information and each of the plurality of sets of third pixel information that meets the predetermined condition (as shown in FIG. 4), and transmits the at least one first address signal and each of the plurality of set of third pixel information that meets the predetermined condition having been resorted to the FIFO circuit 150.

Referring to FIG. 6B, in operation S635, the state control circuit 160 confirms whether the at least one read request Req has been sent to the memory 103, and issues the at least one read request Req to the memory 103 through the data write circuit 180 when the at least one read request Req has not yet been sent to the memory 103. In operation S640, the state control circuit 160 further counts the number of the at least one read request Req sent to the memory 103 to generate the count value CT1. In operation S645, the data write circuit 180 reads the at least one set of first pixel information from the memory 103 according to the at least one read request Req, stores the at least one set of read first pixel information to the memory 120, and issues at least one write completion signal SC.

In operation S650, the data output circuit 170 counts according to the at least one write completion signal SC to generate a count value CT2, reads the at least one set of first pixel information from the memory 120 and reads the at least one first address signal and each of the plurality of sets of third pixel information that meets the predetermined condition having been resorted from the FIFO circuit 150 when the count value CT2 is equal to the count value CT1, and substitutes the at least one set of first pixel information for the at least one first address signal therein, so as to output each of the plurality of sets of third pixel information that meets the predetermined condition having been resorted and the at least one set of first pixel information as a plurality of sets of second pixel information that the interpolation device 102 uses to perform one round of interpolation operation.

Details associated with the multiple operations above may be referred from the details of the multiple embodiments above, and such repeated details are omitted herein for brevity. The multiple operations above are merely examples, and are not limited to being performed in the order specified in this example. Without departing from the operation means and ranges of the various embodiments of the present application, additions, replacements, substitutions or omissions may be made to the operations, or the operations may be performed in different orders.

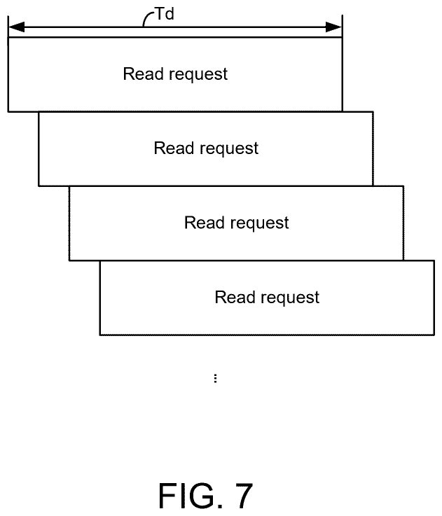

FIG. 7 shows a timing diagram of multiple read requests performed by the projection image correction system 100 in FIG. 1 according to some embodiments of the present application. In some embodiments, the state control circuit 160 may buffer a predetermined number (greater than 1) of the at least one read request Req by the FIFO circuit 340, so as to implement the ability of successively receiving multiple read requests (corresponding to the at least one read request Req) and successively sending multiple read requests to the memory 103. Equivalently speaking, the projection image correction system 100 is able to implement successive and partially parallel data access to reduce the influences of a delay time Td of pixel information read from the memory 120.

In some related art, a projection image correction system needs to completely process one read request (that is, reading required pixel information from a cache in response to one read request) before it can process a next read request. Thus, overall processing efficiency is significantly impaired. Different from the prior art above, as shown in FIG. 7, the state control circuit 160 is able to implement successively receiving multiple read requests and successively sending multiple read requests, thereby improving overall processing efficiency.

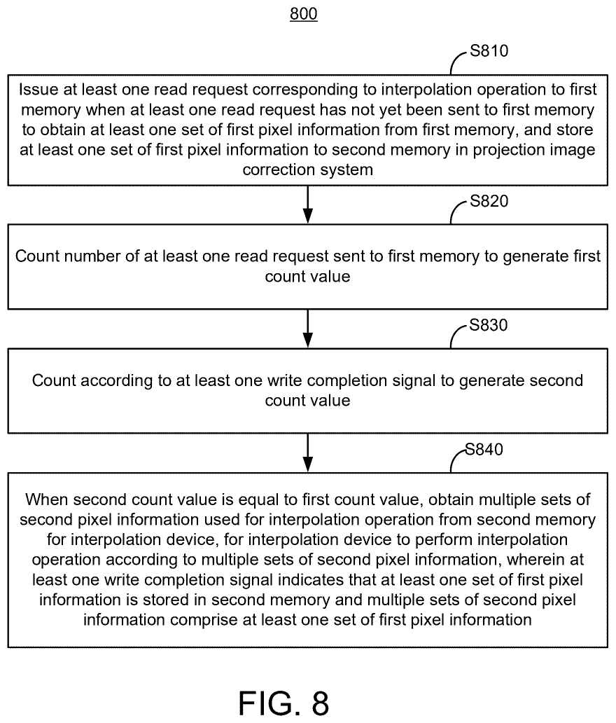

FIG. 8 shows a flowchart of a projection image correction method 800 according to some embodiments of the present application. In some embodiments, the projection image correction method 800 may be performed by, for example but not limited to, the projection image correction system 100 in FIG. 1.

In operation S810, at least one read request corresponding to an interpolation operation is issued to a first memory when the read request has not yet been sent to the first memory to obtain at least one set of first pixel information from the first memory, and the at least one set of first pixel information is stored to a second memory of the projection image correction system. In operation S820, the number of the at least one read request sent to the first memory is counted to generate a first count value. In operation S830, counting is performed according to at least one write completion signal to generate the second count value. In operation S840, when the second count value is equal to the first count value, a plurality of sets of second pixel information used for the interpolation operation are obtained from the second memory for an interpolation device to perform the interpolation operation according to the plurality of sets of second pixel information, wherein the at least one write completion signal indicates that the least one set of first pixel information has been stored to the second memory, and the plurality of sets of second pixel information include the at least one set of first pixel information.

Details associated with the multiple operations of the projection image correction method 800 above can be referred from the details of the multiple embodiments above, and such repeated details are omitted herein. The multiple operations above are merely examples, and are not limited to being performed in the order specified in this example. Without departing from the operation means and ranges of the various embodiments of the present application, additions, replacements, substitutions or omissions may be made to the operations, or the operations may be performed in different orders.

In conclusion, the projection image correction system and the method thereof provided according to some embodiments of the present application are able to implement an operation means of successively receiving read requests and sending requests to a memory to enhance the efficiency of memory data access and reduce the time loss of read data miss, thereby improving processing efficiency of the overall system.

While the present application has been described by way of example and in terms of the preferred embodiments, it is to be understood that the disclosure is not limited thereto. Various modifications may be made to the technical features of the present application by a person skilled in the art on the basis of the explicit or implicit disclosures of the present application. The scope of the appended claims of the present application therefore should be accorded with the broadest interpretation so as to encompass all such modifications.

What is claimed is:

1. A projection image correction system, comprising:
a state control circuit, issuing at least one read request corresponding to an interpolation operation to a first memory when the at least one read request has not yet been sent to the first memory to obtain at least one set of first pixel information from the first memory, storing the at least one set of first pixel information to a second memory, and counting the number of the at least one read request sent to the first memory to generate a first count value; and
a data output circuit, counting according to at least one write completion signal to generate a second count value, and obtaining a plurality of sets of second pixel information used for the interpolation operation from the second memory for an interpolation device when the second count value is equal to the first count value, thus the interpolation device performing the interpolation operation according to the plurality of sets of second pixel information,
wherein the at least one write completion signal indicates that the least one set of first pixel information has been stored to the second memory, and the plurality of sets of second pixel information include the at least one set of first pixel information.

2. The projection image correction system according to claim 1, wherein the state control circuit further records at least one sent request, and compares the at least one read request with the at least one sent request to confirm whether the at least one read request has not yet been sent to the first memory.

3. The projection image correction system according to claim 1, wherein the state control circuit comprises:
a first buffer, storing at least one sent request;
a second buffer, storing the first count value;
a first-in-first-out (FIFO) circuit, issuing the at least one read request to the first memory; and
a controller, comparing the at least one read request with the at least one sent request to confirm whether the at least one read request has not yet been sent to the first memory, issuing the at least one read request to the FIFO circuit when the at least one read request is different from the at least one sent request, storing the at least one read request to the first buffer to update the at least one sent request, and counting the number of the at least one read request sent to the first memory to generate the first count value.

4. The projection image correction system according to claim 1, wherein the data output circuit comprises:
a counter, counting the at least one write completion signal to generate the second count value;
a FIFO circuit, receiving the first count value from the state control circuit; and
an output circuit, obtaining the first count value from the FIFO circuit, and reading the plurality of sets of second pixel information from the second memory when the second count value is equal to the first count value.

5. The projection image correction system according to claim 1, further comprising:
a data write circuit, reading the at least one set of first pixel information from the first memory according to the at least one read request, writing the at least one set of first pixel information to the second memory, and accordingly issuing the at least one write completion signal.

6. The projection image correction system according to claim 1, wherein the second memory comprises a plurality of memory banks, the plurality of memory banks store a plurality of sets of original pixel information of original image data according to a predetermined order, and the plurality of sets of original pixel information comprise the at least one set of first pixel information.

7. The projection image correction system according to claim 1, further comprising:
an address decoding circuit, decoding a received address request signal to obtain a plurality of address signals, and reading a plurality of sets of third pixel information from a plurality of memory banks of the second memory according to the plurality of address signals;
a confirmation circuit, confirming whether each of the plurality of sets of third pixel information meets a predetermined condition; and a data sorting circuit, determining that the second memory lacks the at least one set of first pixel information when at least one of the plurality of sets of third pixel information does not meet the predetermined condition and accordingly issuing the at least one read request, and resorting each of the plurality of sets of third pixel information that meets the predetermined condition and at least one first address signal, wherein the at least one first address signal is one of the plurality of address signals that corresponds to the at least one of the plurality of sets of third pixel information that does not meet the predetermined condition.

8. The projection image correction system according to claim 7, wherein each of the plurality of sets of third pixel information comprises a tag value and a validity value, and if the validity value of a corresponding one of the plurality of sets of third pixel information is a predetermined value and the tag value of the corresponding one is same as a target tag value, the confirmation circuit confirms that the corresponding one meets the predetermined condition.

9. The projection image correction system according to claim 7, further comprising:
a FIFO circuit, receiving each of the plurality of sets of third pixel information that meets the predetermined condition and the at least one first address signal having been resorted from the data sorting circuit,
wherein the data output circuit further substitutes the at least one set of first pixel information for the at least one first address signal having been resorted, and outputs each of the plurality of sets of third pixel information that meets the predetermined condition and the at least one set of first pixel information having been resorted as the plurality of sets of second pixel information.

10. A projection image correction method, performed by a projection image correction system, the projection image correction method comprising:
issuing at least one read request corresponding to an interpolation operation to a first memory when the at least one read request has not yet been sent to the first memory to obtain at least one set of first pixel information from the first memory, and storing the at least one set of first pixel information to a second memory of the projection image correction system;
counting the number of the at least one read request sent to the first memory to generate a first count value;
counting according to at least one write completion signal to generate the second count value; and
when the second count value is equal to the first count value, obtaining a plurality of sets of second pixel information used for the interpolation operation from the second memory for an interpolation device to perform the interpolation operation according to the plurality of sets of second pixel information,
wherein the at least one write completion signal indicates that the at least one set of first pixel information has been stored to the second memory, and the plurality of sets of second pixel information include the at least one set of first pixel information.
